(19) United States
(12) Patent Application Publication
(10) Pub. No.: US 2007/0079591 A1
(43) Pub. Date: Apr. 12, 2007

(54) Aquatic vegetation groomer

(76) Inventor: Douglas E. Lien, Blaine, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 11/545,248

(22) Filed: Oct. 9, 2006

Related U.S. Application Data
(60) Provisional application No. 60/725,607, filed on Oct. 10, 2005.

(51) Int. Cl. A01D 44/00

(52) U.S. Cl. 56/9

(57) ABSTRACT

An aquatic vegetation cutting and removal system is disclosed which is a self-contained floating system having a depth-variable cutting assembly operated in conjunction with a rake device which gathers and removes detached aquatic weeds or other vegetation. The system may be large enough to have a rider-operator or small and light enough to be easily portable.

### BACKGROUND OF THE INVENTION

I. Field of the Invention

The present invention relates generally to aquatic vegetation cutting and removal systems and particularly to a versatile aquatic vegetation cutting and gathering system capable of being attached to a small watercraft or of independent operation as a rider-operated system or as a small lightweight portable device operated by a wader or other individual using an elongated handle.

II. Related Art

Aquatic weed infestation is known to adversely affect fish and wildlife, boating and other recreational activities in lakes and rivers. Heavy aquatic weed growth may block or impede boat movement, damage propellers, or block boat engine cooling systems. In addition, water flow and drainage in irrigation ditches may be seriously slowed by heavy aquatic plant growth. In certain cases, fish may be affected by infestations which restrict light and/or deplete dissolved oxygen needed by the fish. In addition, heavy aquatic plant growth may impede swimming, waterskiing and other recreational activities that seriously affect the value of lakes and rivers.

Aquatic vegetation removal systems have been known for some time. Most of these are very large watercraft with dedicated built-in systems. Examples of these are illustrated and described in U.S. Pat. Nos. 6,023,920, 6,647,704 and 5,481,856. There have also been devices built capable of attachment to smaller watercraft.

Examples of aquatic vegetation cutting and/or removal devices attachable to small watercraft are found, for example, in U.S. Pat. Nos. 5,372,001; 5,189,867 and 5,430,998. However, these systems are generally too complicated in construction to be reliable or are inefficient.

There exists a recognized need for an aquatic vegetation cutting and gathering system that is of inexpensive, rugged construction, yet is self-contained and efficient and able to sever vegetation at various depths and which is operable by an individual or which can be readily attached to and detached from a small watercraft. Such a system would be particularly useful to private individuals owning lakefront property who desire to remove such aquatic vegetation from the vicinity of private docks and beaches.

### SUMMARY OF THE INVENTION

By means of the present invention, there is provided a rugged, versatile aquatic vegetation groomer or harvester in the form of a cutting and gathering system which is self contained but capable of being readily attached to and detached from a small watercraft. The system may have a depth-variable cutting assembly operated in conjunction with a rake device which gathers and moves detached aquatic weeds or other vegetation.

In one embodiment, the cutting assembly features and is carried by a height adjustable platform which carries a drive and cutter subassembly that includes a prime mover, preferably a gasoline engine which is connected through a clutch, which may be, and is preferably, a centrifugal clutch which disconnects at idle, to a gear box or speed reducer which, in turn, has an output shaft connected to one end of an elongate drive shaft which may be protected by a non-rotating outer sleeve. The drive shaft has a free end which is connected to a rotary cutting device. The rotary cutting device may be any suitable such device and, in one preferred embodiment, is in the form of a circular cutting disc that carries a plurality of cutter blades (possibly 8) evenly distributed about the periphery of the cutting disc. Preferably, each of the cutting blades is provided with a slight curvature, the orientation of which is alternated around the periphery of the disc (i.e., curve up, curve down) in an assembled cutting device in order to minimize currents or turbulence in the water which may stir up bottom sediment and complicate retrieving severed vegetation during operation of the device.

The drive and cutter subassembly is mounted through the platform with the drive shaft and rotating cutting device extending below the platform. The platform is carried by a generally vertical post and is designed to travel along the post being raised and lowered by a hand-operated winch and cable system, or the like, enabling cutting at any desired level within the limits of the length of the drive shaft. This part of the apparatus, of course, can also be power-assisted, if desired.

The entire cutting assembly is further carried by a floatation apparatus which preferably includes a pair of spaced, generally parallel pontoons connected by a stabilizing support frame which, in turn, supports the entire cutting assembly. Preferably, the support frame includes isolation or vibration dampeners to eliminate vibrations in the structure caused by the operation of the cutter engine. When the platform is in a fully raised position, the cutting disc and attached blades are well above the water level safely situated between the pontoons at or near the top thereof. In one embodiment, a pair of rotor-molded pontoons rated at 250 pounds floatation each were used. In the fully lowered position, the platform is designed to rest on the interconnecting support frame which also helps to stabilize the system with the cutting disc and shaft fully extended into the water.

The aquatic vegetation harvester is further provided with a gathering rake device which includes an elongated, generally horizontally disposed main or top bar which carries a plurality of shorter spaced parallel tine bars extending generally at right angles from the main bar giving the appearance of a rather large rake head. The rake device may be pivotally mounted so that the tine bars can be rotated into the water or up out of the water as desired. In several embodiments, the generally horizontally disposed main bar is connected across one end of the spaced generally parallel pontoons or a framework carried by the pontoons with the rake tines extending beneath the water line in the deployed position so as to gather cut vegetation rising to the surface of the water in one direction and rotating upward when moved in the reverse direction. It will be appreciated that the length and spacing of the tines can be varied and that in other embodiments, the rake may even be carried as a separate device.

An aquatic vegetation harvester in accordance with the larger embodiment of the invention can be mounted conveniently to the side of any boat, for example, using suction cups attached to an adjustable arm assembly which, in turn, is attached to the support frame. The arm can be adjusted to accommodate a variety of gunwale heights which typically vary from boat to boat. The unit can also be designed as a self-propelled system with an on-board operator or as a remote-controlled, self-powered unit.

An alternate and much smaller, lightweight and portable embodiment of the aquatic vegetation harvester of the invention is also contemplated in which a pivotally-mounted reciprocator device is used in the cutter sub-assembly which employs a round reciprocating blade device as a cutting head. The cutting head is attached to a drive shaft driven by an internal combustion engine. This embodiment also has an attached pivoting rake device and can be operated by a person wading in the water or remotely using an elongated telescoping rod control attachment. This device is only about 3.5 feet long and is floated on small pontoons. It may weight less than 20 pounds.

### BRIEF DESCRIPTION OF THE DRAWINGS

In the drawings wherein like numerals designate like parts throughout the same:

FIG. 1 is a perspective view of an aquatic vegetation cutting system in accordance with the present invention attached to the side of a motor vessel or powered watercraft with the platform fully lowered, but sans rake;

FIG. 2 depicts an aquatic vegetation cutting system similar to that in FIG. 1 with an associated rake device shown carried by the watercraft;

FIG. 3 is a rearview of an embodiment of the aquatic vegetation cutting system of the invention with the platform in a raised disposition;

FIG. 4 is a front perspective view of the embodiment of FIG. 3;

FIG. 5 is a front view of the embodiment of FIGS. 3 and 4 showing the platform in a fully lowered position and showing the winch;

FIG. 6 is a rearview of a self-contained embodiment of the aquatic vegetation cutting system with a gathering rake device attached to the pontoons;

FIG. 7 is a rear perspective view of the embodiment of FIG. 6;

FIG. 8 depicts a self-propelled, rider-operated embodiment of the aquatic vegetation cutting system of the invention;

FIG. 9 is a perspective view of an alternate embodiment without a gathering rake attached;

FIG. 10 shows the embodiment of FIG. 9 with a telescoping attachment for remote operation;

FIG. 11 depicts a partial view of an embodiment similar to that of FIG. 9 with a gathering rake attached and in the raised position;

FIG. 12 is an enlarged fragment of FIG. 11 showing the gathering rake in a generally vertical or deployed position;

FIG. 13 is a greatly enlarged fragmentary perspective view of a locking system for the cutting device of the embodiment of FIG. 9; and

FIG. 14 is a perspective drawing of a possible cutting device for use in the embodiment of FIGS. 9-13.

### DETAILED DESCRIPTION

The following detailed description is of one or more representative embodiments of the aquatic vegetation harvester or cutting and gathering system of the invention and is intended to show examples of an implementation of the invention and is not intended to limit the scope of the invention in any manner. It is believed that a variety of variations within the scope of the concepts of the invention may occur to those skilled in the art.

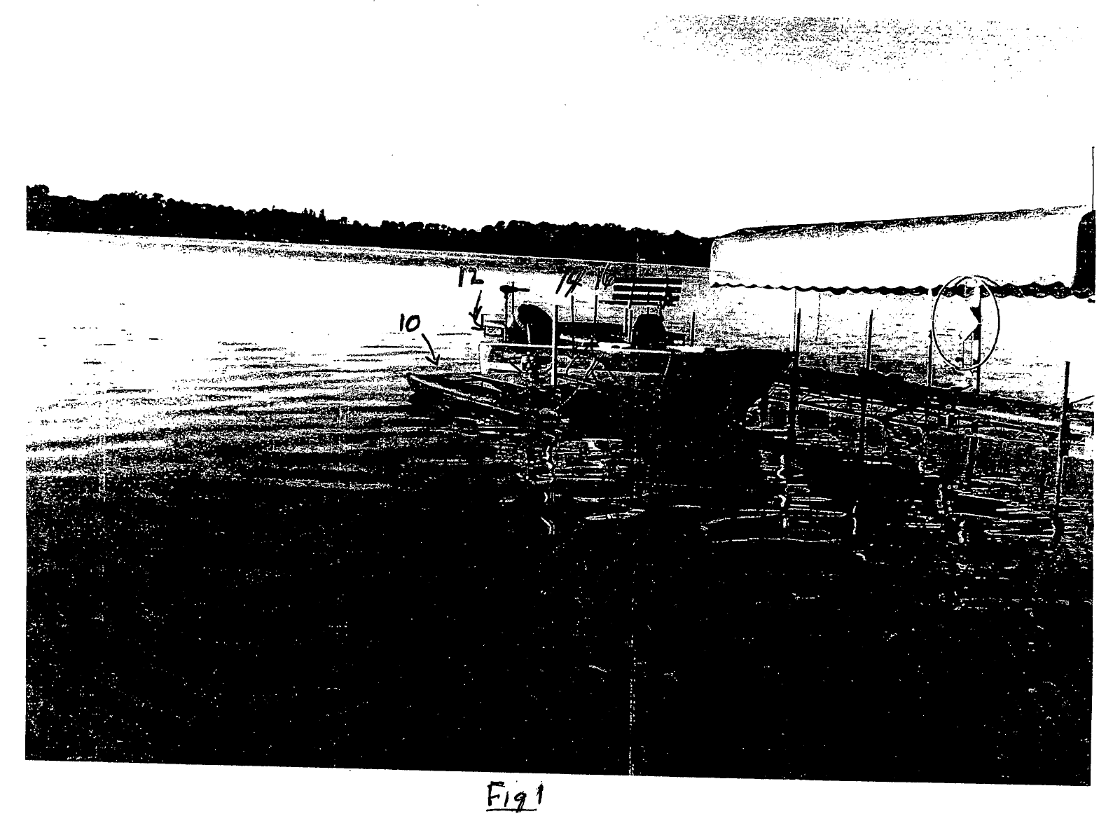

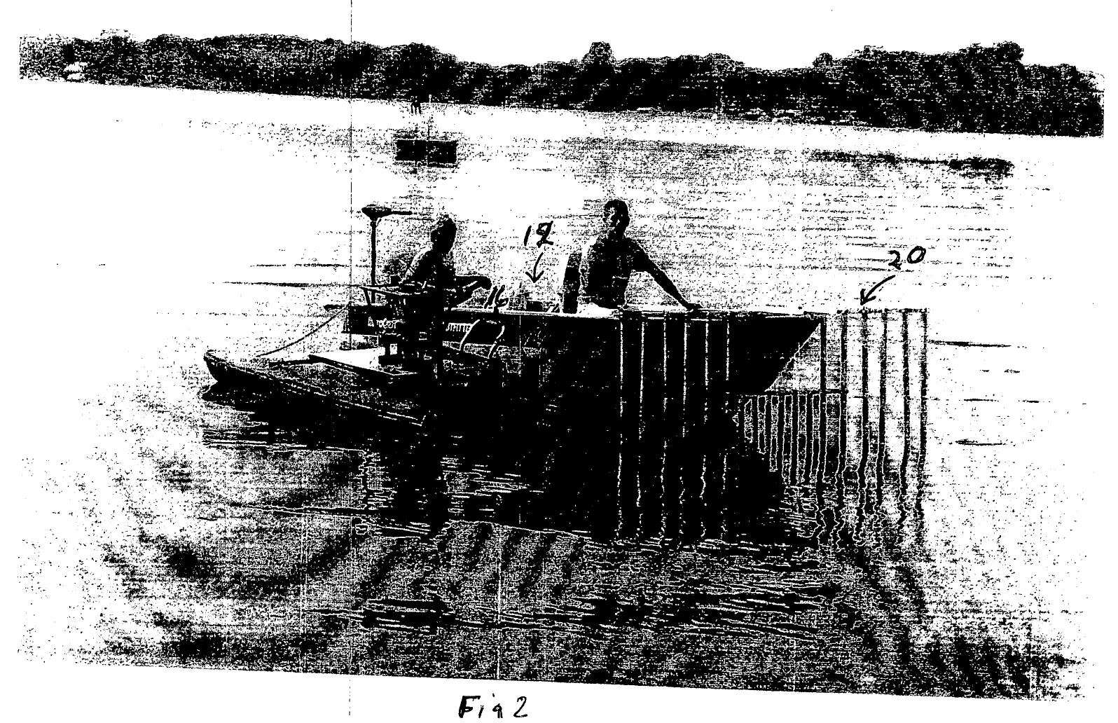

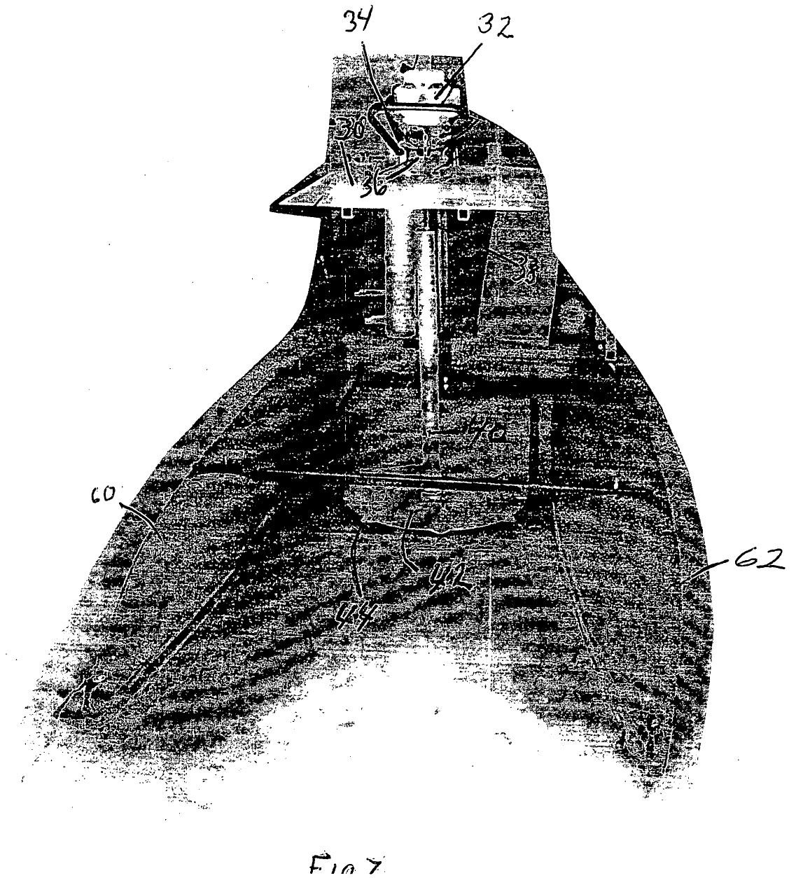

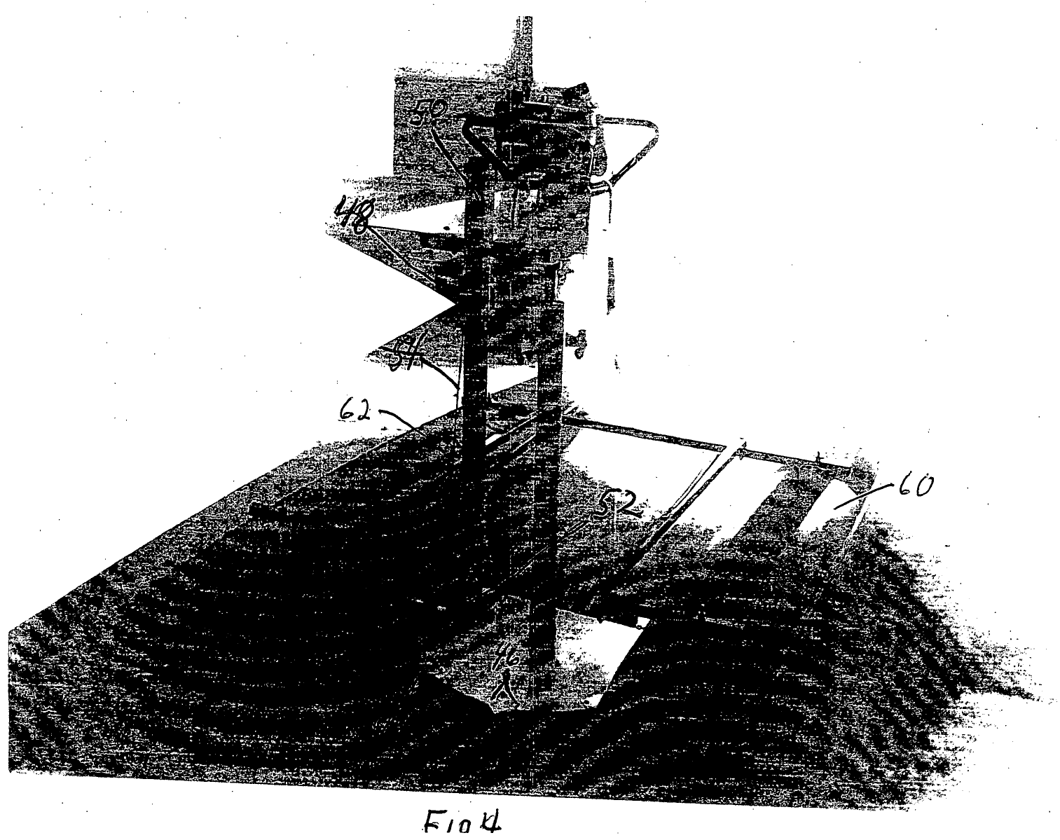

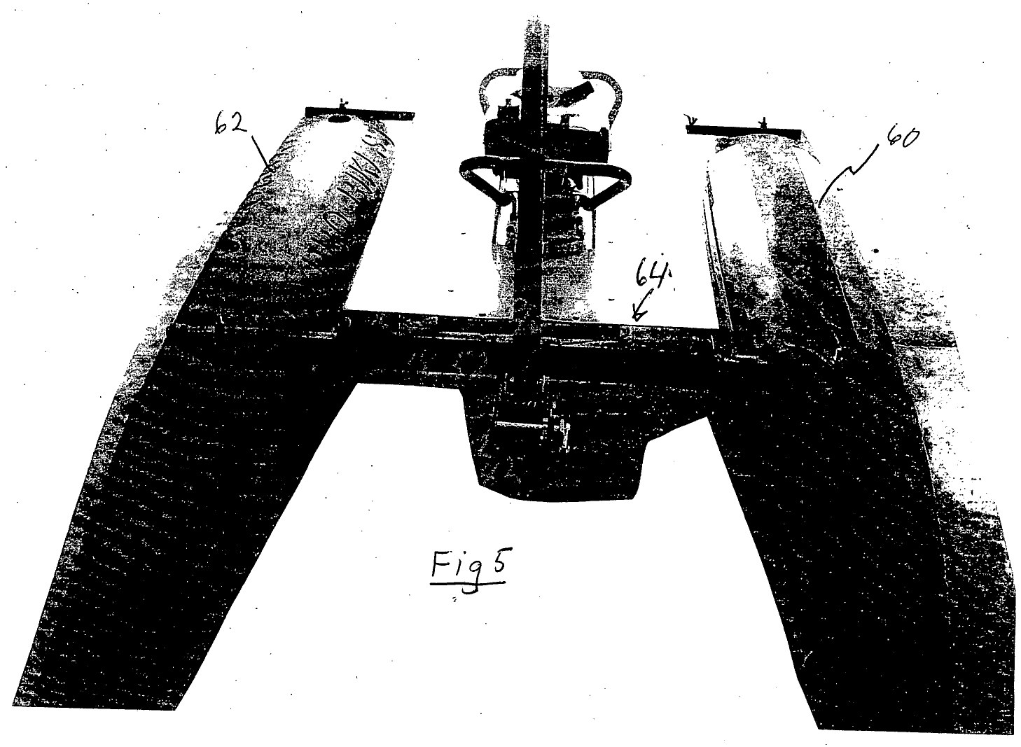

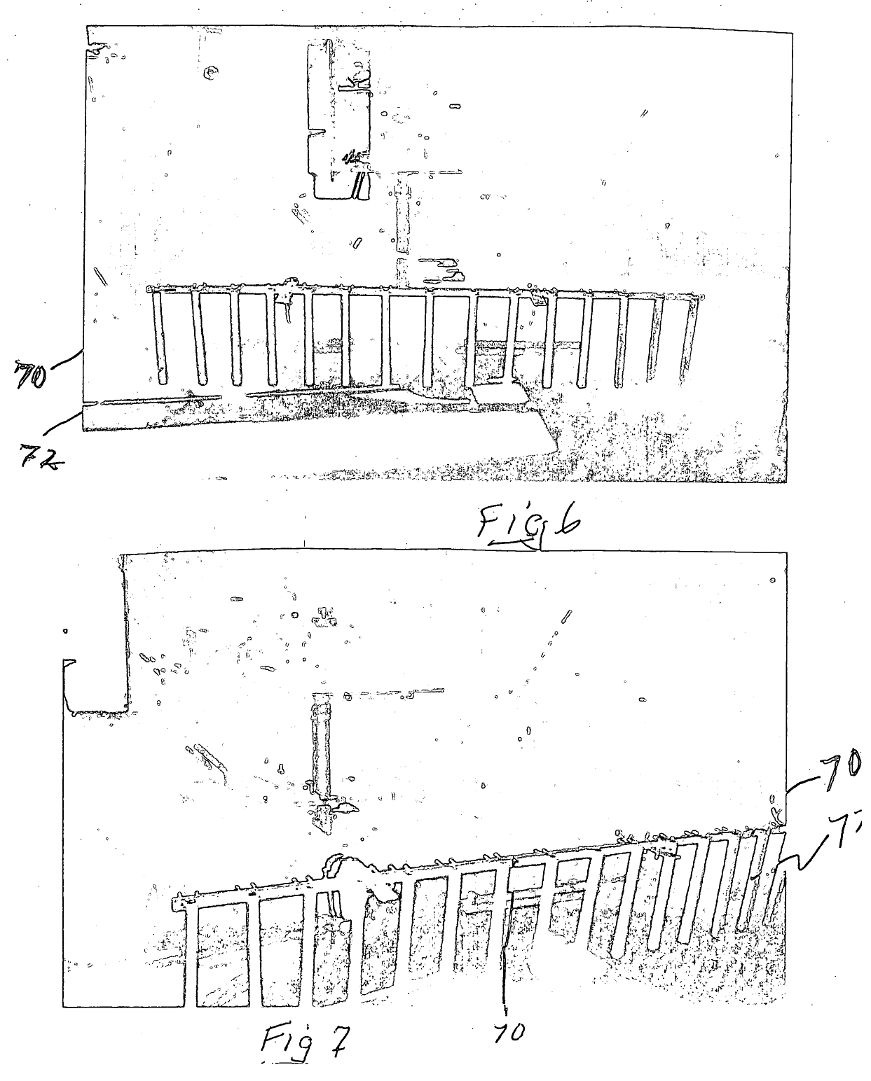

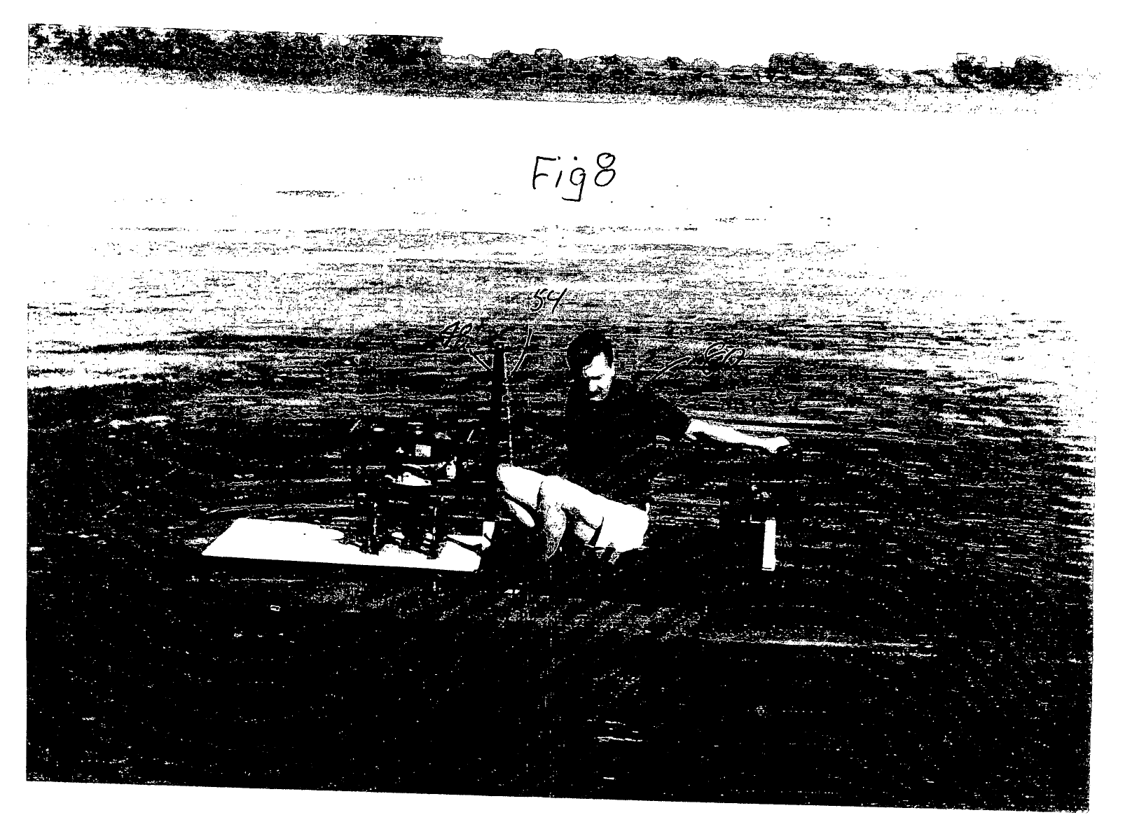

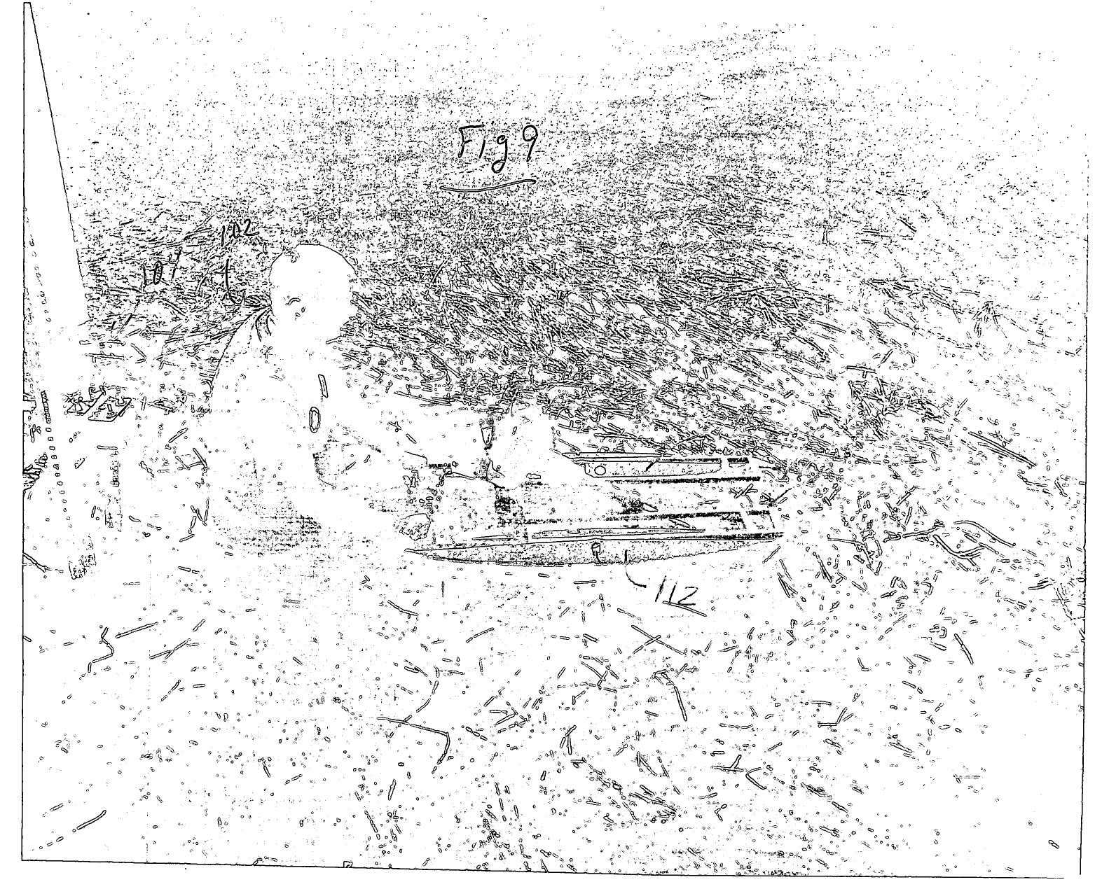

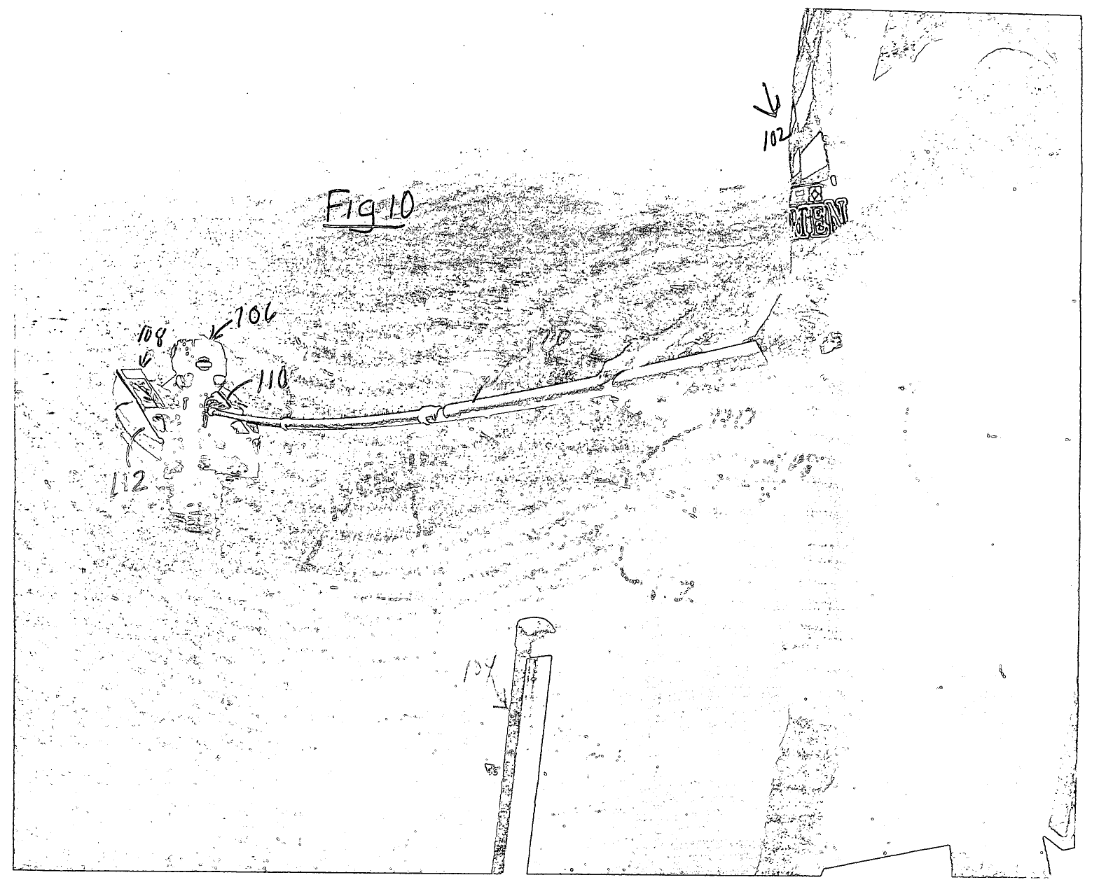

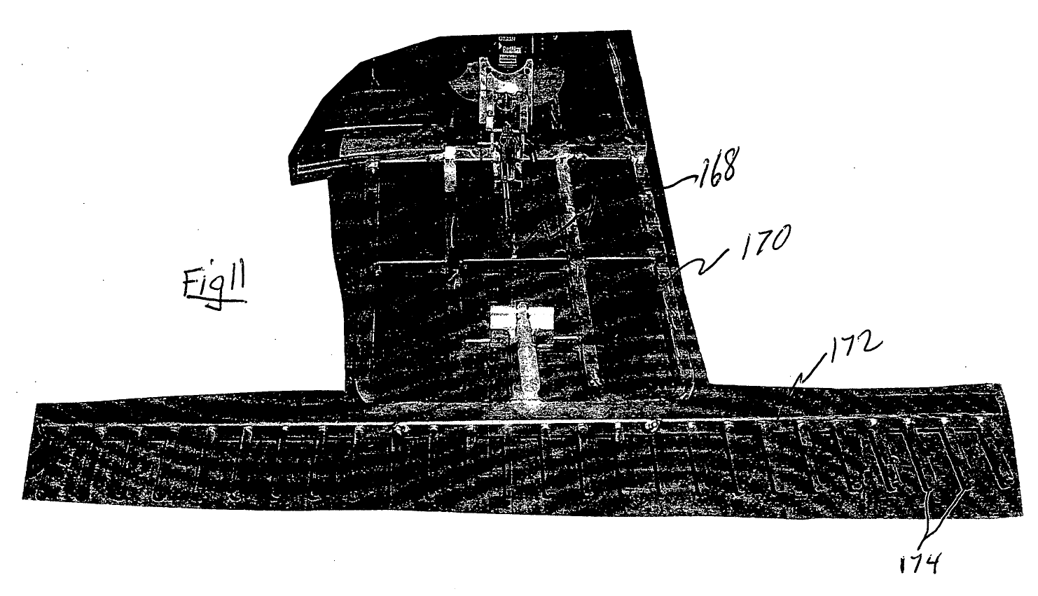

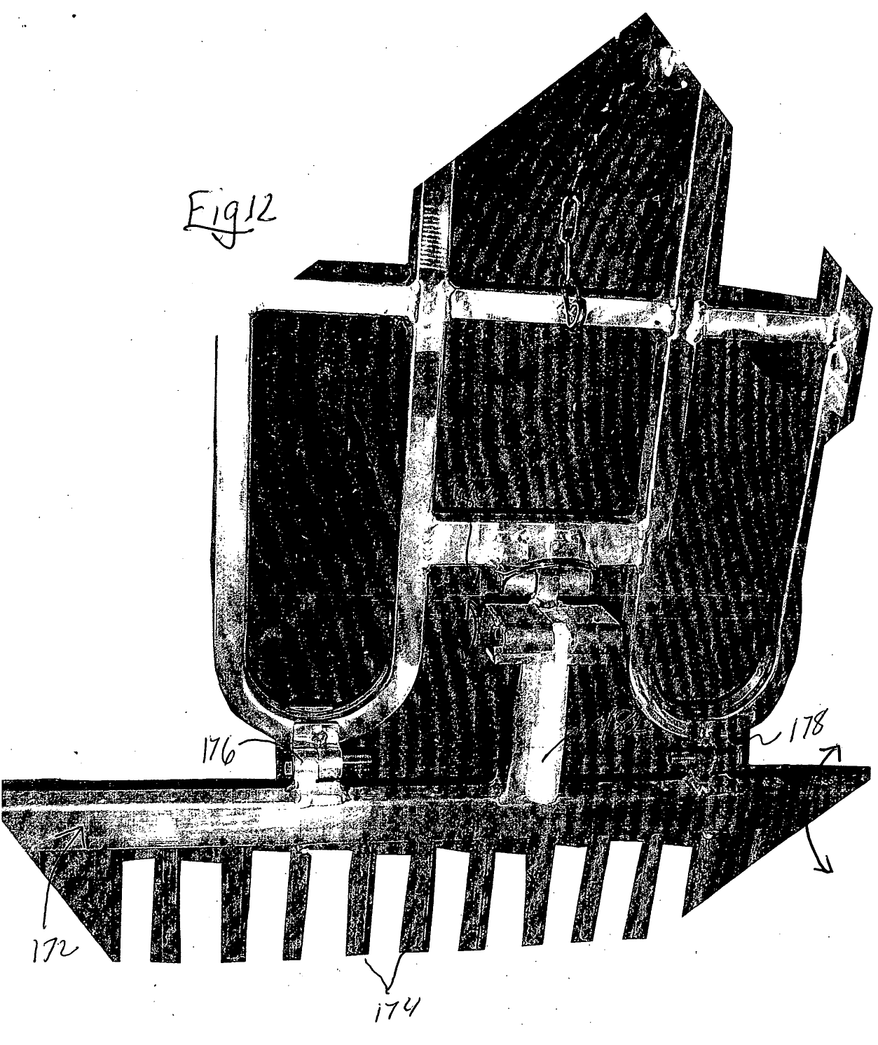

FIG. 1 is a perspective view showing an embodiment of an aquatic vegetation cutting system in accordance with the present invention generally at 10 attached to a motorized watercraft 12 using an adjustable arm system 14. FIG. 2 depicts the aquatic vegetation cutting system similar to that shown in FIG. 1 with an embodiment of an associated gathering rake device 20 shown carried by the watercraft 12. Details of this embodiment of a vegetation cutting and harvesting system itself are depicted better in FIGS. 3-7.

The system features a height-variable cutting assembly shown in FIGS. 3-5 which includes a height-adjustable platform 30 which carries a gasoline engine 32 which is connected through a clutch mechanism 34 to a gear box or speed reducer 36 which, in turn, has an output shaft connected to one end of an elongate drive shaft 38 shown protected by a non-rotating sleeve 40 which may be a length of PVC tubing. This prevents enlargement of the rotating shaft with the vegetation being cut. The drive shaft is connected at its free end to a rotary cutting device 42 which is illustrated as a circular cutting disc that carries a plurality of cutter blades 44 attached thereto, as by bolts 46 (FIG. 4). Preferably, each of the cutting blades 44 is provided with a slight curvature which is alternated (curve up, curve down) about the disc in an assembled cutting device to prevent turbulence in the water during operation of the device, as will be described.

As shown in FIG. 4, the platform 30 on which the cutting system is mounted is carried by a sleeve 50 which fits slidably over a post 48 in a manner which allows vertical adjustment along the post controlled by a winch 52 with cable 54. The cable is strung over the post and connected to the platform 30 in a conventional manner. The winch illustrated is a geared, hand-crank model, however, a power winch can be used if desired.

In FIGS. 3-4, the system is shown in a raised position and in FIG. 5 in a fully lowered position. It will be appreciated that any position in between can be addressed.

The system is supported on a floating platform which includes a pair of spaced, generally parallel pontoons 60, 62 connected by a stabilizing support frame 64 which supports the entire cutting assembly. It should be noted that when the platform is in the fully lowered position it is designed to rest on the support frame connecting the pontoons. The stabilizing support frame may also be provided with isolation dampers to eliminate vibration caused by the operation of the cutting system including the gasoline engine.

One version of this embodiment of the aquatic vegetation or weed cutting system utilized a 3.8 horsepower gasoline engine of the class often used for digging postholes. The output shaft of the gasoline engine was connected to a 3-inch centrifugal clutch which allows the system to idle until the engine reaches a certain rpm which is determined by a spring-tension in the clutch after which the force is fully transmitted to the cutter. The output of the centrifugal clutch is connected to a gear reducer which may have a speed reduction ratio of 20:1 which reduces, for example, a gasoline engine turning at 5800 rpm to about 290 rpm with corresponding higher torque at the output of the gear reducer. The drive shaft coupled to the output shaft of the gear reducer may be of any convenient length depending on the depth of cutting desired, but is generally 3-5 feet in length. One embodiment used a 24-inch diameter aluminum cutting disc provided with 8 cutting teeth in the form of attached cycle blades.

The floatation pontoons for this embodiment may be rotor-molded pontoons, about six feet in length and possibly rated at 250 pounds floatation and the platform height-adjusting winch system may include a conventional 1,000-pound lift winch, or the like. It will further be appreciated that, while the embodiment is shown as being attached to the side of a motorized watercraft utilizing an arm system and suction cups, the system could clearly be attached in a different manner or remote-controlled or be provided with a motor itself and an operator's seat for an on-board operator.

FIGS. 6 and 7 depict an embodiment similar to that shown in FIGS. 3-5 with an attached aquatic vegetation gathering rake device which includes an elongated, generally horizontally disposed bar 70 which carries a plurality of spaced, generally vertically disposed bar 72 and is fixed to the end of the pontoons 60, 62. The rake device is mounted so that it can be rotated upward pulling the tines 72 out of the water, if desired. The rake is designed to push severed aquatic vegetation when moved in one direction and, conversely, to dump the gathered vegetation when the system is moved in reverse.

FIG. 8 depicts a rider-operated self-propelled embodiment shown without an attached gathering rake and includes an on-board operator 80 and drive motor 82. It will be understood that a gathering rake may be attached as in other embodiments.

In operation, the system is guided to an area where vegetation is sought to be severed with the cutting platform in the fully raised position. Note that the cutting disc and teeth are then positioned between the pontoons and are safely in a protected area. Once an area in which vegetation is to be cut is reached, the height of the platform 30 can be adjusted so that the cutter disc 42 and teeth 44 are at the desired depth for cutting. Thereafter, the motor is activated and speeded up to engage the shaft and drive the cutter as the system is moved through the water. The alternate curvature of the teeth prevents undue turbulence which may stir up sediment from the bottom of the lake or river in which vegetation is sought to be cut and also may interfere with the efficiency of the cutting disc. As severed vegetation floats to the surface, the rake can be used to gather cut vegetation and push it into shore or to any other desired collection point. The depth of the cut can be adjusted periodically as desired during the operation of the device and once cutting is finished, the platform is restored in its fully upright position with the disc clear of the water.

An alternative embodiment is depicted in FIGS. 9-14. This is generally a much smaller, portable, lightweight model capable of operation by someone wading in the water and handling and guiding the device or the device may be operated remotely by someone on shore or on a dock, for example, using an extended control handle. Thus, in FIG. 9, there is shown an aquatic vegetation harvesting system generally at 100 being handled by an operator 102 wading near a dock 104. The system includes a vegetation trimming device 106 which is adjustably, pivotally mounted on a frame 108 which spans a pair of floatation pontoons 110 and 112.

FIG. 10 depicts the embodiment of FIG. 9 with a telescoping rod 120 attached for remote operation as from the dock 104.

An example of an embodiment of the trimming device 106 itself is shown in greater detail in FIG. 14 and includes a gasoline engine 130 with connected centrifugal clutch 132 which is connected to a drive shaft (not shown) contained in a non-rotating drive shaft housing 134. The drive shaft is connected through a cutter case 136 to a round reciprocating-type cutter blade 138. A debris guard is shown at 140 and the device is provided with a loop handle at 142. An ignition switch and throttle mechanism is shown at 144 which connects to a throttle cable at 146. Such reciprocator devices are available commercially as from Komatsu Zenoah America Inc. of Narcross, Ga.

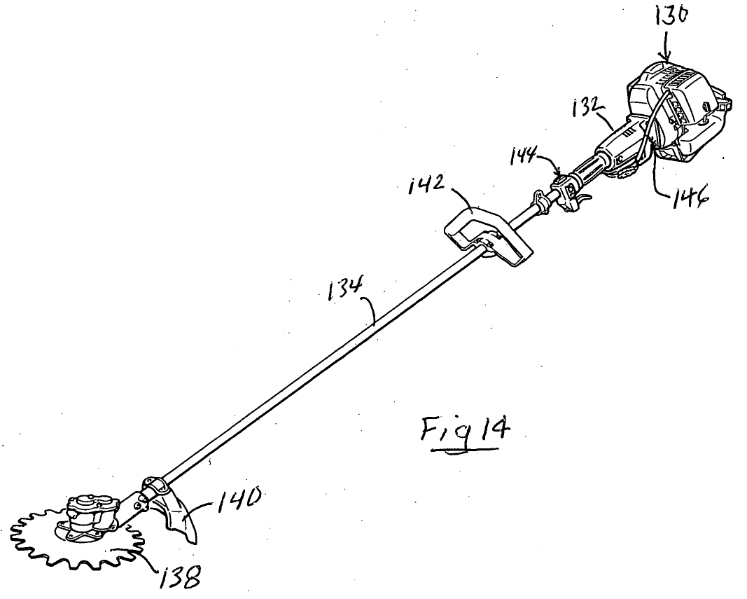

As shown best in the greatly enlarged view of FIG. 13, the vegetation trimming device 106 is mounted in fixed relation to a pivoting bracket 150 which may be locked in the raised position with the cutting blade held out of the water by a locking pin 152 which latches a pair of bracket eyes 154, 156 to a latch eye at 158. The degree of pivotal motion allotted to the vegetation trimming device is controlled by a play-out chain 160 having one end fixed to the framework 170 as at 168 in cooperation with a latch hook device 162 fixed to bracket 150 as by hex nuts 164, 166. With the latch pin removed, the height of the cutting blade 138 can be adjusted in the water by increasing or decreasing the length of the chain attached to the hook device 162.

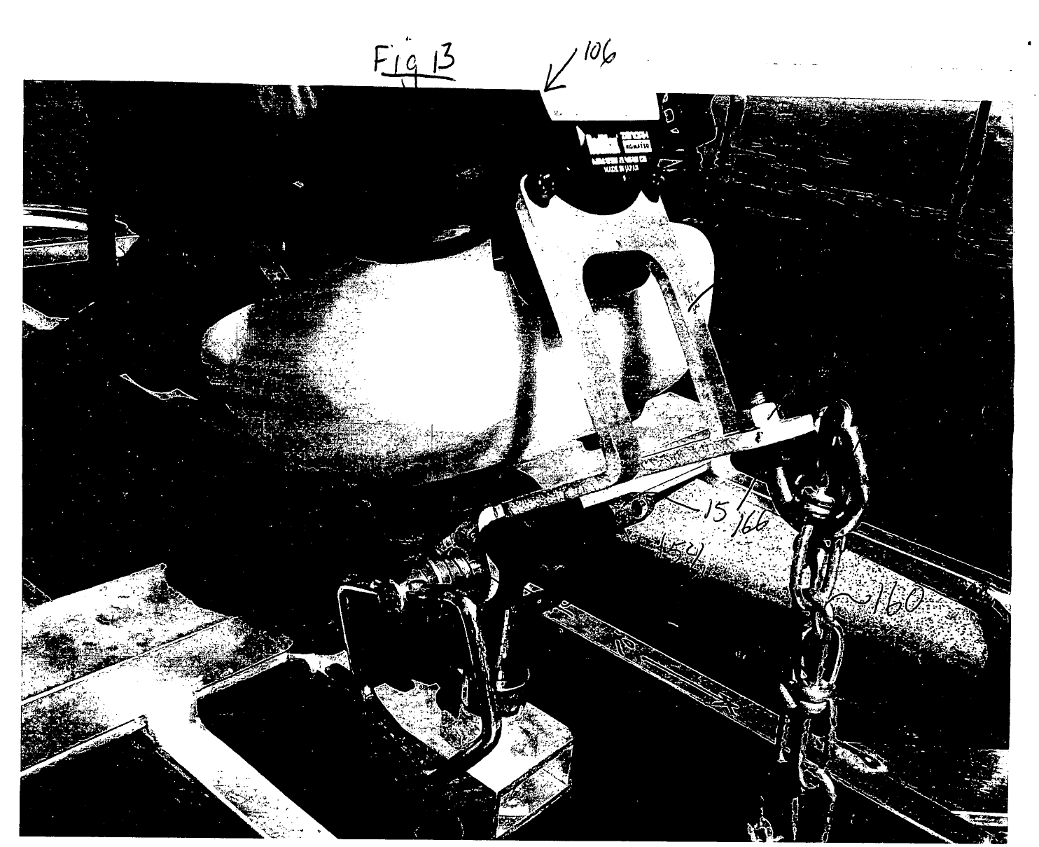

The enlarged views of FIGS. 11 and 12 depict a gathering rake system that attaches to the embodiment of FIG. 9 shown here with a modified frame at 170 and includes a relatively flat rake device 172 with an array of spaced, fixed parallel tines 174 pivotally mounted on spaced hinges 176, 178 (FIG. 12) with a control pivot mounting 180 which includes a pivotally mounted connector which is designed to connect to a telescoping rod as at 120 (FIG. 10). The rake device 172 is shown in a raised or out of water posture in FIG. 11 generally parallel to the frame 170 and in a deployed or generally vertical gathering posture in FIG. 12. Thus, with reference also to FIG. 10, when the aquatic vegetation harvester is urged away from the operator, the gathering rake can be pivoted to the raised position as desired by someone operating the device who is in the water with the device or using the elongated remote control handle as in FIG. 10. Thus, with reference also to FIG. 10, when the aquatic vegetation harvester is urged away from the operator using the telescoping handle 120, the connector 182 urges the rake device to assume the raised out of water posture during a cutting stroke and, conversely, when the handle is urged toward the operator, the rake is pivoted into the deployed or collection posture and cut weeds or other plant growth that floats to the surface of the water is gathered and urged toward the operator, accordingly.

The smaller sized embodiment of FIGS. 9-14 may be no more than about 1 meter in length and weigh as little as 20 pounds. The floats and frame can be made of any suitable material and successful lightweight models have been fabricated using aluminum pontoons and an aluminum welded frame, together with an aluminum rake device. These materials also resist deterioration by corrosion in the water.

In operation, the smaller embodiment can be carried to a desired location where underwater vegetation is to be removed and placed in the water. The trimming device should be in the raised, locked position. The engine can then be started and the device released from the locked position and with the engine at idle and the cutting blade not reciprocating. The system can then be rotated in the mount to adjust the cutter blade 138 to the desired depth for cutting by playing out and fastening the chain 160 with hook 162. Once the chain is adjusted, the engine speed can be adjusted for cutting using the throttle control mechanism. It has been found that although the blade angle changes as the drive shaft and cutter blade depth are varied, the cutting efficiency remains quite good. Vegetation can be severed from a few inches below the surface to a depth of three feet or more using the portable device. Once set to cut, the device can be maneuvered by a wader or remotely using a telescoping attachment. Cut vegetation can be removed using the rake as desired.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. An aquatic vegetation harvesting apparatus operable by an individual comprising:
(a) a pair of spaced aquatic floatation devices joined by a support framework;
(b) a vegetation trimming device having an elongated shaft and a cutter blade mounted on said framework in a manner which allows the depth of the cutter blade to be adjusted;
(c) a system for adjusting the depth of said cutter blade and locking it in place; and
(d) a rake device for gathering and moving vegetation severed by said trimming device.

2. An apparatus as in claim 1 which is portable and lightweight and deployable by an individual.

3. An apparatus as in claim 2 further comprising an extendable elongate handle device for remote operation by an individual.

4. An apparatus as in claim 3 wherein said rake device is mounted to said framework in a manner such that it is able to pivot between a raised and a deployed position.

5. An apparatus as in claim 4 wherein said elongate handle operates said rake device.

6. An apparatus as in claim 4 wherein said elongate handle is a telescoping device.

7. An apparatus as in claim 1 wherein said vegetation trimming device is pivotally mounted to said framework.

8. An apparatus as in claim 1 including a height-adjustable platform attached to said framework for adjusting the depth of the cutter blade.

9. An apparatus as in claim 1 further comprising an arrangement for attaching said apparatus to a water craft.

10. An apparatus as in claim 1 which is able to support an individual operator riding on said apparatus.

11. An apparatus as in claim 1 wherein said trimming device includes a reciprocating cutter blade.

12. An apparatus as in claim 1 wherein said trimming device includes a rotating cutter head.

13. An apparatus as in claim 1 wherein said floatation devices are pontoons.
